(19) United States
(12) Patent Application Publication
(10) Pub. No.: US 2010/0194904 A1
(43) Pub. Date: Aug. 5, 2010

(54) IMAGE PICKUP APPARATUS AND METHOD FOR SIGNAL PROCESSING IN IMAGE PICKUP APPARATUS

(75) Inventor: Ken TAKAHASHI, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/623,696

(22) Filed: Nov. 23, 2009

(30) Foreign Application Priority Data
Feb. 3, 2009 (JP) 2009-022907

(51) Int. Cl. H04N 5/228; G06K 9/00

(52) U.S. Cl. 348/222.1; 382/168; 348/E05.031

(57) ABSTRACT

An image pickup apparatus including an image pickup device having a plurality of photodiodes regularly disposed, a reference voltage signal generation section which generates a reference voltage signal in a nonlinear pattern, and an AD conversion section which converts an analog signal output from each of the photodiodes into a digital signal on the basis of the reference voltage signal from the reference voltage signal generation section.

This application claims the benefit of Japanese Application No. 2009-022907 filed in Japan on Feb. 3, 2009, the contents of which are incorporated herein by this reference.

### BACKGROUND OF THE INVENTION

1. Field of the invention

The present invention relates to an image pickup apparatus having an AD conversion section for converting an analog signal from light receiving elements into a digital signal, and to a method for signal processing in the image pickup apparatus.

2. Description of the Related Art

In an image pickup apparatus such as a well-known digital camera, an analog signal output from light receiving elements is converted into a digital signal having a predetermined number of bits by an AD conversion section, and then various kinds of correction processing are performed on the digital signal. For example, in a case of a video dark as a whole and low in contrast, contrast correction processing is performed on a digital signal for the video. In contrast correction processing on a digital signal, the quantization width by which the digital signal is quantized, i.e., the voltage corresponding to one bit, is expanded on the basis of an upwardly convex correction pattern. There is, therefore, a possibility of steps of quantization being so increased that gradations are coarse or a noticeable stepped portion appears in the video. That is, since all correction processes are performed in the digital signal in well-known image pickup apparatus, there is a possibility of degradation in video quality when processing is performed in such a manner that the quantization width is increased.

The applicant of the present invention disclosed in Japanese Patent Application Laid-Open Publication No. 2007-135099 an AD converter having a variable voltage device whose output voltage value is set to a predetermined value in a display device which performs displaying after AD conversion of an input analog signal. This AD converter converts an input analog signal into a digital signal on the basis of a nonlinear correction pattern. This AD converter is designed specially for a display device such as a television receiver and cannot be used for an image pickup apparatus such as a digital camera.

Japanese Patent Application Laid-Open Publication No. 2006-157263 discloses an image pickup apparatus having a column AD conversion section in which an analog signal output from light receiving elements is converted into a digital signal on the basis of a reference voltage signal in a linear pattern.

### BRIEF SUMMARY OF THE INVENTION

According to one aspect of the present invention, there is provided an image pickup apparatus which outputs a digital video signal, including an image pickup device having a plurality of light receiving elements regularly disposed, a reference voltage signal generation section which generates a reference voltage signal in a nonlinear pattern, and an AD conversion section which converts an analog signal output from each of the plurality of light receiving elements into a digital signal having a predetermined number of bits on the basis of the reference voltage signal from the reference voltage signal generation section, and outputs the digital video signal.

According to another aspect of the present invention, there is provided a signal processing method for an image pickup apparatus which outputs a digital video signal, including outputting an analog signal from each of a plurality of light receiving elements regularly disposed in an image pickup device, and converting by an AD conversion section the input analog signal into a frame-by-frame digital video signal on the basis of a reference voltage signal in a nonlinear pattern generated by a reference voltage signal generation section.

### BRIEF DESCRIPTION OF THE DRAWINGS

FIG. 1 is a schematic diagram showing the configuration of an image pickup apparatus according to a first embodiment of the present invention;

FIG. 2 is a diagram for explaining a pattern of a reference voltage signal generated by a reference voltage signal generation section of a well-known image pickup apparatus;

FIG. 3 is a diagram for explaining AD conversion processing performed by an AD conversion section of the well-known image pickup apparatus;

FIG. 4 is a diagram for explaining AD conversion processing performed by the AD conversion section of the well-known image pickup apparatus;

FIG. 5 is a diagram for explaining contrast correction processing performed in a video processing section of the well-known image pickup apparatus;

FIG. 6 is a diagram for explaining a pattern of a reference voltage signal generated by a reference voltage signal generation section of the image pickup apparatus according to the first embodiment;

FIG. 7 is a diagram for explaining AD conversion processing performed by an AD conversion section of the image pickup apparatus according to the first embodiment;

FIG. 8 is a diagram for explaining AD conversion processing performed by the AD conversion section of the image pickup apparatus according to the first embodiment;

FIG. 9 is a diagram for explaining a pattern of a reference voltage signal generated by the reference voltage signal generation section of the image pickup apparatus according to the first embodiment;

FIG. 10 is a schematic diagram showing the configuration of an image pickup apparatus according to a second embodiment of the present invention;

FIG. 11 is a flowchart for explaining the flow of processing in the image pickup apparatus according to the second embodiment;

FIGS. 12A and 12B are diagrams for explaining AD conversion processing in the image pickup apparatus according to the second embodiment;

FIGS. 13A and 13B are diagrams for explaining AD conversion processing in the image pickup apparatus according to the second embodiment;

FIGS. 14A and 14B are diagrams for explaining AD conversion processing in the image pickup apparatus according to the second embodiment;

FIG. 15 is a flowchart for explaining the flow of processing in the image pickup apparatus according to modified example 1 of the second embodiment;

FIG. 16 is a flowchart for explaining the flow of processing in the image pickup apparatus according to modified example 2 of the second embodiment; and

FIG. 17 is a schematic diagram showing the configuration of an image pickup apparatus according to a third embodiment of the present invention.

### DETAILED DESCRIPTION OF THE PREFERRED EMBODIMENTS

### First Embodiment

An image pickup apparatus 1 according to a first embodiment of the present invention will be described with reference to the accompanying drawings.

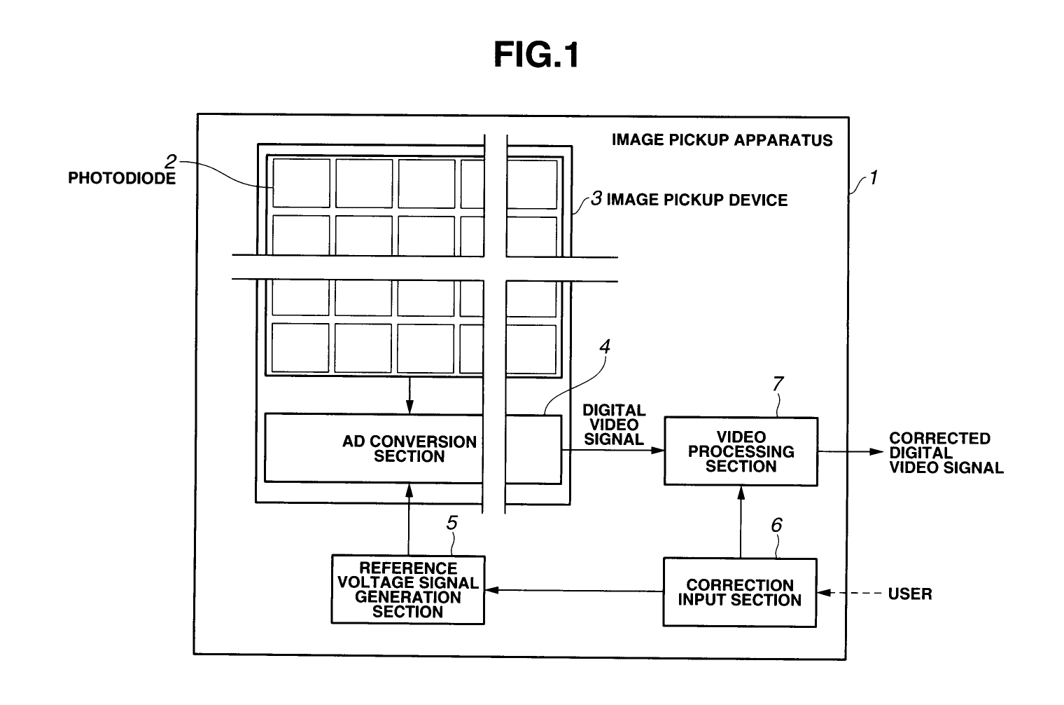

As shown in FIG. 1, the image pickup apparatus 1 of the present embodiment is provided with an image pickup device 3 having a plurality of photodiodes 2 as light receiving elements regularly disposed in matrix form, a reference voltage signal generation section 5 which generates a reference voltage signal in a nonlinear pattern, an AD conversion section 4 which converts an analog signal output from each photodiode 2 into a digital signal of a predetermined number of bits on the basis of the reference voltage signal from the reference voltage signal generation section 5, a correction input section 6 to which a correction processing command from a user for example is input, a video processing section 7 which performs correction processing on a digital video signal. The digital video signal is a video signal for one frame of video picked up by the plurality of photodiodes 2, i.e., a frame signal constituted by digital signals corresponding to the number of photodiodes 2.

The AD conversion section 4 of the image pickup apparatus 1 is an on-chip/column AD conversion section formed on the chip of the image pickup device 3 together with the photodiodes 2. The column AD conversion section has a column-by-column AD conversion processing function with respect to the photodiodes 2 regularly disposed in matrix form, and performs parallel processing on a column-by-column basis. The light receiving elements are not limited to the photodiodes 2. Any other elements capable of photoelectric conversion of incident light may suffice as light receiving elements. The array of photodiodes 2 of the image pickup device 3 is not limited to a matrix form. Any other regularly arranged array of photodiodes 2, e.g., a honeycomb form may suffice.

The reference voltage signal generation section 5 generates a reference voltage (V-REF) signal in a predetermined nonlinear pattern and outputs the reference voltage signal to the AD conversion section 4. The predetermined pattern means the form of voltage change by increasing monotonously from VL to VH with time.

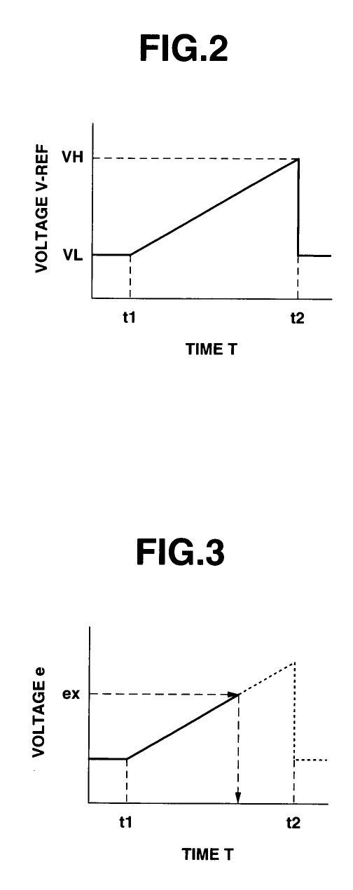

AD conversion processing and contrast correction processing in the well-known image pickup apparatus will be described by way of example with reference to FIGS. 2 to 5.

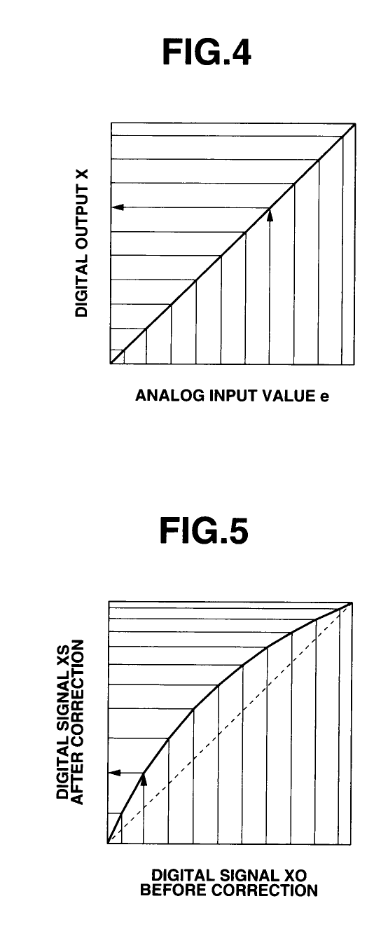

As shown in FIG. 2, a reference voltage signal generated by a reference voltage signal generation section in the well-known image pickup apparatus is a signal in a linear pattern such that the voltage increases monotonously from VL to VH with time in a time period from t1 to t2. As shown in FIG. 3, in the well-known AD conversion section, an analog signal (e) output from each photodiode 2 is converted into a digital signal (X), on the basis of the amount of charge accumulated in a predetermined capacitor (not shown) in the time period until the voltage ex of the analog signal (e) becomes equal to the voltage of the reference voltage signal. That is, as shown in FIG. 4, an analog signal is converted into a digital signal on the basis of a reference voltage signal in a linear pattern by AD conversion processing performed in the well-known AD conversion section.

In the well-known image pickup apparatus, contrast correction processing is performed on the digital video signal if the video after AD conversion processing is dark and has low contrast. In contrast correction processing on the digital video signal, however, the quantization width of the digital signal XO before correction is expanded to the quantization width of the digital signal XS after correction on the basis of an upwardly convex correction pattern as shown in FIG. 5, so that the video quality in a low-voltage region, i.e., a dark-portion region, degrades.

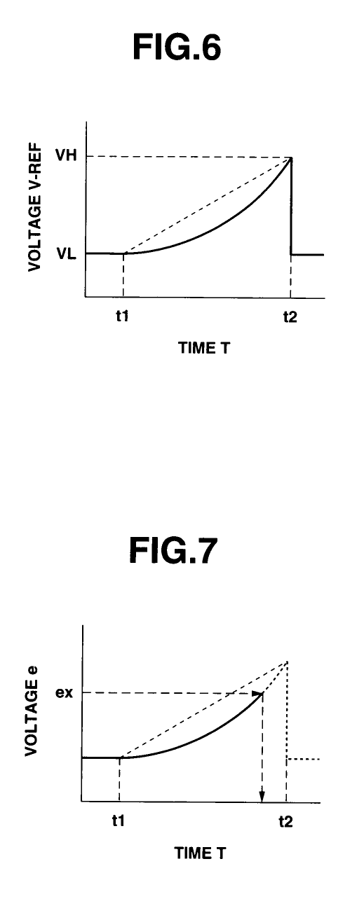

AD conversion processing performed in the image pickup apparatus 1 according to the first embodiment of the present invention will now be described with reference to FIGS. 6 to 9.

As shown in FIG. 6, the reference voltage (V-REF) signal generated by the reference voltage signal generation section 5 of the image pickup apparatus 1 in the present embodiment is a signal in a nonlinear pattern increasing monotonously from VL to VH with time. A user gives a reference voltage signal pattern to the reference voltage signal generation section 5 through the correction input section 6. For example, in a case of a dark video having low contrast, the signal density of a dark portion is high. With respect to such a video, therefore, a user gives a downwardly convex pattern such as shown in FIG. 6.

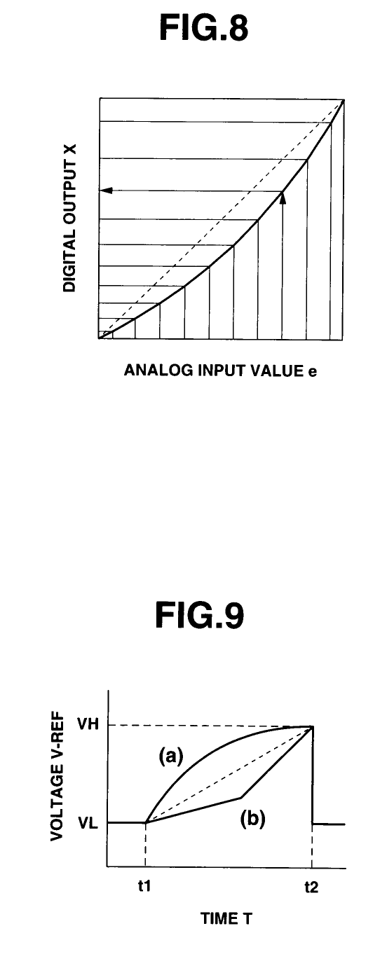

In the AD conversion section 4, as shown in FIG. 7, an analog signal (e) output from each photodiode 2 is converted into a digital signal (X) on the basis of the amount of charge accumulated in a capacitor (not shown) before the voltage ex of the analog signal (e) becomes equal to the reference voltage. That is, in the AD conversion section 4 of the image pickup apparatus 1, as shown in FIG. 8, an analog signal output from each photodiode 2 is converted nonlinearly into a digital signal on the basis of the reference voltage signal in a nonlinear pattern from the reference voltage signal generation section 5.

As a result, as shown in FIG. 8, the voltage width corresponding to each bit in a dark-portion region in which the voltage of the analog signal (analog input value: e) output from the photodiode 2 is low, that is, the signal density is high, is smaller than the voltage widths corresponding to bits in the other region, in other words, the quantization density in the dark-portion region is higher.

Other correction processes such as lightness correction processing and chromaticity correction processing are performed on the digital video signal after AD conversion processing in the video processing section 7 under commands from the correction input section 6.

The image pickup apparatus 1 is capable of performing video processing, for example, even on a video having a dark portion of a low lightness in a large proportion and having a low contrast by densely quantizing the video signal in the dark-portion region in which the signal density is high. That is, the image pickup apparatus 1 in the present embodiment is capable of outputting a high-quality digital video signal.

A reference voltage signal pattern can be set as desired according to the contents of a video. That is, a pattern for increasing the quantization density at a position where the signal density is high according to a signal density distribution suffices.

For example, while a downwardly convex pattern is used for a video having a dark portion in a large proportion and a low contrast as already described, an upwardly convex pattern is used for a video having a light portion in a large proportion with a high signal density thereof and having a low contrast as shown in FIG. 9(a). Further, reference voltage signal patterns are not limited to curves. A nonlinear pattern formed by combining a plurality of linear patterns as shown in FIG. 9(b) may suffice.

### Second Embodiment

An image pickup apparatus 1B according to a second embodiment of the present invention will be described with reference to the drawings.

The image pickup apparatus 1B according to the second embodiment is similar to the image pickup apparatus 1 according to the first embodiment. The components of the second embodiment identical to those of the first embodiment are indicated by the same reference numerals and the description thereof will not be repeated.

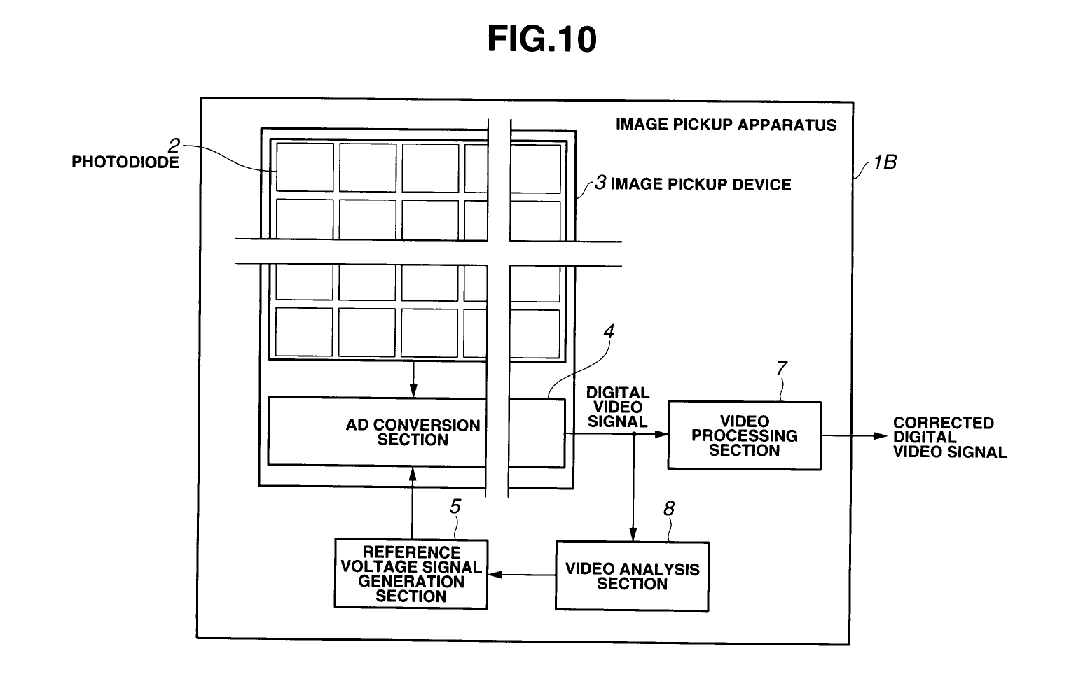

As shown in FIG. 10, the image pickup apparatus 1B in the present embodiment has a video analysis section 8 for analyzing a digital video signal of an image picked up by the image pickup device 3. The reference voltage signal generation section 5 generates a signal in a nonlinear pattern based on the results of analysis performed by the video analysis section 8. That is, in the image pickup apparatus 1 B, the video analysis section 8 designates a reference voltage signal pattern in place of a user designating a reference voltage signal pattern in the image pickup apparatus 1 in the first embodiment.

For example, the video analysis section 8 performs video analysis, e.g., histogram analysis with respect to each of frames of the digital video signal, i.e., frames formed by digital signals corresponding to the number of photodiodes 2. Histogram analysis is a method in which a region where data exists is divided into a certain number of sections and analysis is performed on the basis of the frequencies of data contained in each section. The video analysis section 8 determines, whether or not the digital video signal has a dark portion in a large proportion and has a low contrast on the basis of a histogram using as a parameter the digital video signal output corresponding to the lightness, i.e., the voltage of the analog signal, and designates a reference voltage signal pattern for increasing the quantization density at a position where the signal density is high according to the signal density distribution of the video signal.

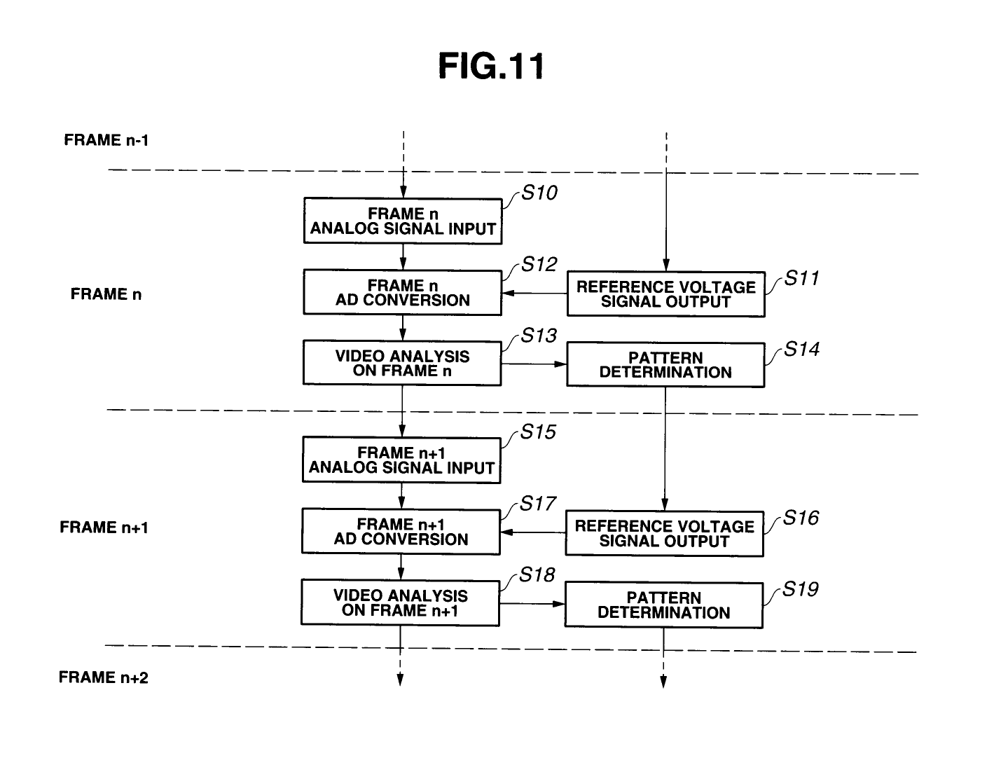

The flow of processing in the image pickup apparatus 1B in the present embodiment will be described with reference to the flowchart of FIG. 11. The image pickup apparatus 1B outputs a digital video signal on a frame-by-frame basis.

### <Step S10>

A frame n analog signal is input to the AD conversion section 4.

### <Steps S11, S12>

The AD conversion section 4 converts the frame n analog signal into a digital signal on the basis of a reference voltage signal generated by the reference voltage signal generation section 5.

The reference voltage signal in a pattern n is based on a pattern determined at the time of processing on a frame n−1 which is an immediate preceding frame, as described below.

### <Step S13>

The video analysis section 8 performs histogram analysis on the frame n digital video signal.

### <Step S14>

The reference voltage signal generation section 5 determines a pattern for increasing the quantization density at a position where the signal density is high according to the signal density distribution of the video signal on the basis of the results of analysis on the frame n in the video analysis section 8. A method for this pattern determination will be described below.

### <Step S 15>

A frame n+1 analog signal is input to the AD conversion section 4.

### <Steps S16, S17>

The AD conversion section 4 converts the frame n+1 analog signal into a digital signal on the basis of a reference voltage signal generated by the reference voltage signal generation section 5. The reference voltage signal in a pattern n+1 is based on the pattern determined at the time of processing on the immediate preceding frame, i.e., the past frame n.

### <Steps S18, S19>

The steps S18 and S19 are the same as steps S13 and S 14.

As described above, the reference voltage signal generation section 5 generates a reference voltage signal in a pattern based on the video signal of the immediate preceding frame. With respect to the video signal of the first frame, the reference voltage signal generation section 5 generates a reference signal, for example, in an initial pattern set in advance.

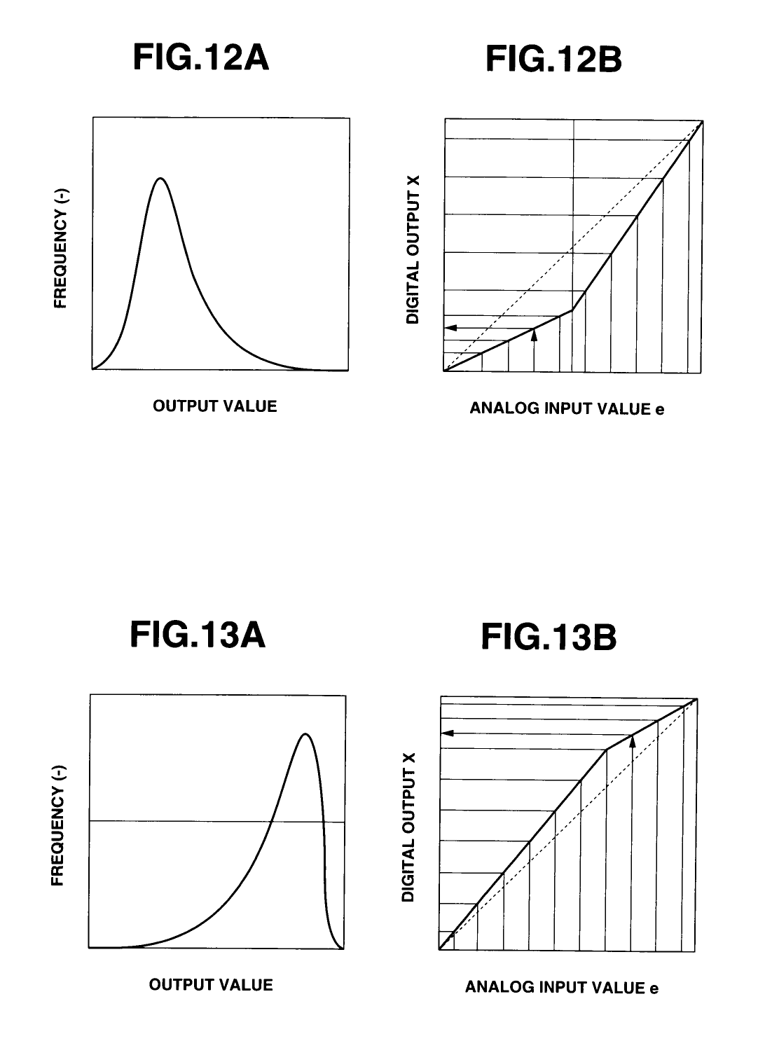

FIG. 12A illustrates a histogram of a digital video signal having a dark portion in a large proportion. In such a case, the video analysis section 8 determines, on the basis of histogram analysis, as a reference voltage signal pattern, a downwardly convex nonlinear pattern having a straight line with a gentler gradient with respect to a low-voltage region, i.e., a dark-portion region and a straight line with a steeper gradient with respect to a high-voltage region, i.e., a light-portion region. As a result, with respect to the low-voltage region, i.e., the dark-portion region, the voltage width corresponding to each bit is reduced in comparison with the other region, as shown in FIG. 12B.

The gradients of straight lines in a reference voltage signal pattern, a point of change in the pattern and the like are determined on the basis of histogram analysis.

On the other hand, FIG. 13A illustrates a histogram of a digital video signal having a light portion in a large proportion. In such a case, the video analysis section 8 determines, on the basis of histogram analysis, as a reference voltage signal pattern, an upwardly convex nonlinear pattern having a straight line with a steeper gradient with respect to a low-voltage region and a straight line with a gentler gradient with respect to a high-voltage region. As a result, with respect to the high-voltage region, i.e., the light-portion region, the voltage width corresponding to each bit is reduced in comparison with the other region, as shown in FIG. 13B.

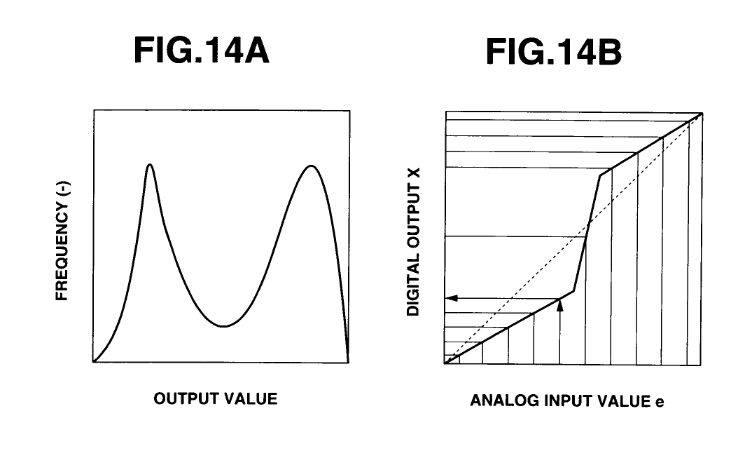

FIG. 14A illustrates a histogram of a digital video signal having dark and light portions in large proportions and a medium-lightness portion in a small proportion. In such a case, the video analysis section 8 determines, on the basis of histogram analysis, as a reference voltage signal pattern, a nonlinear pattern having straight lines with gentler gradients with respect to low-voltage and high-voltage regions and a straight line with a steeper gradient with respect to a medium-voltage region between the low-voltage and high-voltage regions. As a result, with respect to the low-voltage region, i.e., the dark-portion region, and the high-voltage region, i.e., the light-portion region, the voltage width corresponding to each bit is reduced in comparison with the medium-voltage region, as shown in FIG. 14B.

Thus, in the image pickup apparatus 1 B, the reference voltage signal generation section 5 generates a reference voltage signal in a pattern for increasing the quantization density at a position where the signal density is high according to a signal density distribution of a digital video signal. That is, the image pickup apparatus 1B is capable of outputting a high-quality digital video signal by densely quantizing an objective region.

In the video processing section 7, other correction processes such as lightness correction processing and chromaticity correction processing not changing the quantization width are performed on the digital video signal after AD conversion processing as required according to commands from the correction input section (not shown).

The image pickup apparatus 1B in the present embodiment has the advantage which the image pickup apparatus 1 in the first embodiment has, and has improved operability because a suitable reference voltage signal pattern according to a video is determined on the basis of the results of analysis in the video analysis section 8.

### Modified Examples 1, 2 of Second Embodiment

Image pickup apparatuses according to modified examples of the second embodiment of the present invention will be described with reference to the drawings.

Image pickup apparatuses according to modified examples of the second embodiment are similar to the image pickup apparatus 1B according to the second embodiment. The components of the modified examples of the second embodiment identical to those of the second embodiment are indicated by the same reference numerals and the description thereof will not be repeated.

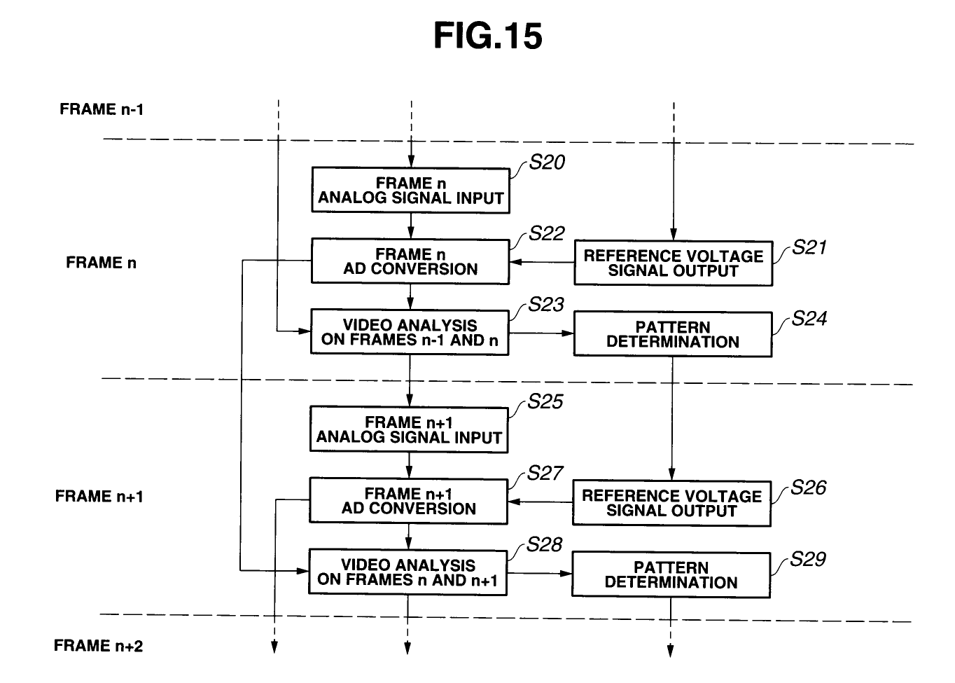

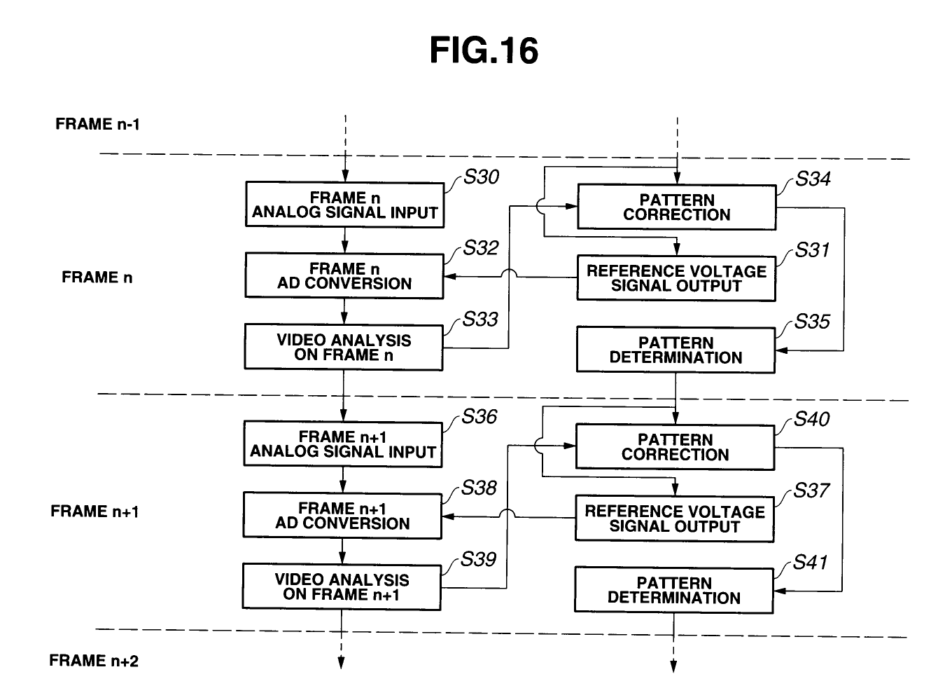

As shown in FIG. 15, the reference voltage signal generation section 5 of the image pickup apparatus in modified example 1 of the second embodiment determines a pattern of a frame n+1 reference voltage signal according to the results of analysis of frames n−1 and n. As shown in FIG. 16, the reference voltage signal generation section 5 of the image pickup apparatus in modified example 2 of the second embodiment reflects the results of analysis of past frames by correcting past reference voltage signal patterns.

That is, the reference voltage signal generation section 5 of the image pickup apparatus in modified example 1 or 2 of the second embodiment outputs a reference voltage signal pattern on the basis of the results of analysis of a plurality of past consecutive frames. The reference voltage signal generation section 5 may output the pattern on the basis of the results of analysis of three or more past frames or on the basis of the results of analysis of not consecutive frames but every several frames.

The image pickup apparatuses in the present modified examples have the advantage which the image pickup apparatus 1B in the second embodiment has, and have improved operability because a suitable reference voltage signal pattern according to a video is determined on the basis of the results of analysis of a plurality of past frames.

In the image pickup apparatus in modified example 1 of the second embodiment, the amount of data may become large because a plurality of past frames are directly stored. In contrast, in the image pickup apparatus in modified example 2 of the second embodiment, the amount of data to be stored is small because storage of only past analysis results suffices.

### Third Embodiment

An image pickup apparatus 1C according to a third embodiment of the present invention will be described with reference to the drawing.

The image pickup apparatus 1C according to the third embodiment is similar to the image pickup apparatus 1B according to the second embodiment. The components of the third embodiment identical to those of the second embodiment are indicated by the same reference numerals and the description thereof will not be repeated.

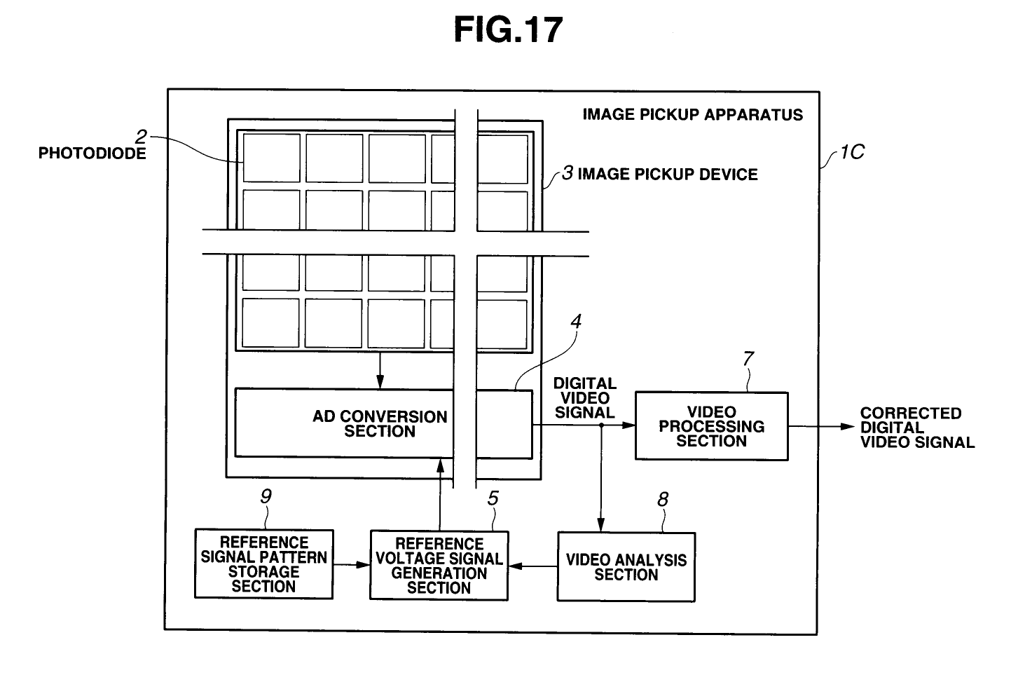

As shown in FIG. 17, the image pickup apparatus IC in the present embodiment has a reference voltage signal pattern storage section 9 for storing reference voltage signal patterns in advance. The reference voltage signal generation section 5 generates one of the plurality of reference voltage signal patterns stored in the reference voltage signal pattern storage section 9.

The image pickup apparatus 1C in the present embodiment has the advantage which the image pickup apparatus 1B in the second embodiment has, and has an increased signal processing speed.

Also, the reference signal pattern storage section described in the description of the image pickup apparatus 1C in the third embodiment may be added as a component for the image pickup apparatus 1 in the first embodiment.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An image pickup apparatus which outputs a digital video signal, comprising:
an image pickup device having a plurality of light receiving elements regularly disposed;
a reference voltage signal generation section which generates a reference voltage signal in a nonlinear pattern; and
an AD conversion section which converts an analog signal output from each of the plurality of light receiving elements into a digital signal having a predetermined number of bits on the basis of the reference voltage signal from the reference voltage signal generation section, and outputs the digital video signal.

2. The image pickup apparatus according to claim 1, wherein the AD conversion section is a column AD conversion section.

3. The image pickup apparatus according to claim 2, further comprising a video analysis section which analyzes the digital video signal, wherein the reference voltage signal generation section generates the reference voltage signal in the nonlinear pattern on the basis of the results of analysis performed by the video analysis section.

4. The image pickup apparatus according to claim 3, wherein the video analysis section performs video analysis on the digital video signal, and the reference voltage signal generation section generates, according to a signal density distribution of the digital video signal, the reference voltage signal in the nonlinear pattern such that the quantization density in a region in which the signal density is high is higher than the quantization density in a region in which the signal density is low.

5. The image pickup apparatus according to claim 4, wherein the region in which the signal density is high and which corresponds to a low voltage of the analog signal is a dark-portion region, and the region in which the signal density is low is a light-portion region.

6. The image pickup apparatus according to claim 5, wherein the video analysis performed by the video analysis section is frame-by-frame histogram analysis on frames of the digital video signal.

7. The image pickup apparatus according to claim 6, wherein if the frames have the dark-portion region in a large proportion, the nonlinear pattern is in downwardly convex form.

8. The image pickup apparatus according to claim 6, wherein if the frames have the light-portion region in a large proportion, the nonlinear pattern is in upwardly convex form.

9. The image pickup apparatus according to claim 6, wherein if the frames have the dark-portion region and the light-portion region in large proportions and have a medium-lightness region in a small proportion, the nonlinear pattern has a straight line with a gentler gradient with respect to the low-voltage region and the high-voltage region and has a straight line with a steeper gradient with respect to a medium-voltage region between the high and low voltages.

10. The image pickup apparatus according to claim 2, further comprising a reference signal voltage pattern storage section which stores a plurality of the nonlinear patterns, wherein the reference voltage signal generation section generates the reference voltage signal on the basis of one of the plurality of nonlinear patterns stored in the reference signal voltage pattern storage section.

11. The image pickup apparatus according to claim 3, wherein the reference voltage signal generation section generates the reference voltage signal in the nonlinear pattern on the basis of the results of video analysis on a plurality of frames performed by the video analysis section.

12. The image pickup apparatus according to claim 11, wherein the reference voltage signal generation section generates the reference voltage signal in the nonlinear pattern on the basis of the results of the video analysis on consecutive frames of the plurality of frames.

13. The image pickup apparatus according to claim 11, wherein the reference voltage signal generation section generates the reference voltage signal in the nonlinear pattern on the basis of the results of the video analysis on the plurality of frames at predetermined intervals.

14. A signal processing method for an image pickup apparatus which outputs a digital video signal, comprising:
outputting an analog signal from each of a plurality of light receiving elements regularly disposed in an image pickup device; and
converting by an AD conversion section the input analog signal into a frame-by-frame digital video signal on the basis of a reference voltage signal in a nonlinear pattern generated by a reference voltage signal generation section.

15. The signal processing method for an image pickup apparatus according to claim 14, wherein the AD conversion section is a column AD conversion section.

16. The signal processing method for an image pickup apparatus according to claim 15, wherein a video analysis section performs histogram analysis on the digital video signal, and the reference voltage signal generation section generates, on the basis of the results of analysis performed by the video analysis section, according to a signal density distribution of the digital video signal, a reference voltage signal in a pattern having a high quantization density at a position where the signal density is high.

17. The signal processing method for an image pickup apparatus according to claim 16, wherein the reference voltage signal generation section generates the reference voltage signal in the nonlinear pattern corresponding to one of a plurality of patterns stored in a reference voltage signal pattern storage section.

18. The signal processing method for an image pickup apparatus according to claim 17, wherein the reference voltage signal generation section generates the pattern on the basis of the results of the analysis performed on a frame-by-frame basis.

19. The signal processing method for an image pickup apparatus according to claim 17, wherein the reference voltage signal generation section generates the pattern on the basis of the results of the analysis on a plurality of frames.

20. An image pickup apparatus which outputs a digital video signal, comprising:
an image pickup device having a plurality of light receiving elements regularly disposed, each of the light receiving elements outputting an analog signal;
a reference voltage signal generation section which generates a reference voltage signal in a nonlinear pattern for converting the analog signal into a digital signal;
a column AD conversion section which is an on-chip section formed on one chip together with the image pickup device, and which converts each of the analog signals output from the plurality of light receiving elements into a digital signal having a predetermined number of bits on the basis of the reference voltage signal from the reference voltage signal generation section, and outputs the digital video signal;
a video analysis section which performs histogram analysis with the lightness of the frame-by-frame digital video signal used as a parameter; and
a reference voltage signal pattern storage section which stores a plurality of the patterns,
wherein the reference voltage signal generation section generates, on the basis of the results of analysis on the plurality of frames performed by the video analysis section, the reference voltage signal in the pattern according to a signal density distribution of the patterns stored in the reference voltage signal pattern storage section.
